(19) United States
(12) Patent Application Publication
(10) Pub. No.: US 2017/0307437 A1
(43) Pub. Date: Oct. 26, 2017

(54) OPTO-MECHANICAL TRANSDUCER FOR THE DETECTION OF VIBRATIONS

(71) Applicant: Phonoptics, Orsay (FR)

(72) Inventors: Vivien Staehle-Bouliane, Saclay (FR); Jean-Michael Malavieille, Mennecy (FR); Francois-Louis Malavieille, Chatenay Malabry (FR)

(21) Appl. No.: 15/516,356

(22) PCT Filed: Oct. 1, 2014
(86) PCT No.: PCT/FR2015/052626

§ 371 Date: Mar. 31, 2017

(30) Foreign Application Priority Data
Oct. 1, 2014 (FR) 1459383

(51) Int. Cl. G01H 9/00; G01H 11/00

(52) U.S. Cl. CPC G01H 9/004; G01H 11/00

(57) ABSTRACT

The present invention relates to an opto-mechanical transducer comprising an optical fibre exhibiting a polished pointed distal end placed opposite a reflecting surface and a proximal end being linked up to a coupler combining an illumination optical fibre associated with a light source and a measurement optical fibre associated with a photo-detector. The reflecting element exhibits a movable zone with an axial component, the axial distance between the distal end of the optical fibre and said reflecting surface at rest is determined so that the reflected luminous intensity I₀ is equal to P·Iₘₐₓ where Iₘₐₓ denotes the maximum reflected luminous intensity, and P is a parameter lying between 0.25 and 0.75.

### CROSS-REFERENCE TO RELATED APPLICATIONS

This application is a national phase entry under 35 U.S.C. §371 of International Patent Application PCT/FR2015/052626, filed Oct. 1, 2015, designating the United States of America and published as International Patent Publication WO 2016/051096 A1 on Apr. 7, 2016, which claims the benefit under Article 8 of the Patent Cooperation Treaty and under 35 U.S.C. §119(e) to French Patent Application Serial No. 1459383, filed Oct. 1, 2014, the disclosure of each of which is hereby incorporated herein in its entirety by this reference.

### TECHNICAL FIELD

This disclosure relates to the field of optomechanical transducers for detecting vibrations, continuous or periodic pressure variations, and for capturing acoustic signals in the air or in a fluid, including in hostile environments.

It relates more particularly to the field of transducers using the optical variation in the light transmitted by one or more optical fibers.

### BACKGROUND

In the prior art, a solution described in European patent EP 0082615 is known. This patent describes a transducer for detecting acoustic signals or the like that are applied to it. The transducer comprises two striated parts forming an optical grating interacting with an optical-fiber waveguide. Resilient means fixed to the striated parts provide a movement perpendicular to the waveguide.

The solution proposed by the European patent EP 0027540 is also known, describing an optical transducer with an optical waveguide provided with two paths for the propagation of the light, which is deformed in response to variations in acoustic pressure or other parameters to be measured for modulating the amplitude of the light propagated along one of the two paths with opposite polarities. The light outputs on the two paths are captured by photodetectors and applied to an electrical differentiation circuit.

The international patent application WO 1993/007686 describes an optical microphone that comprises a vibrating membrane defining a diaphragm intended to receive acoustic signals. An optical element such as a lens is fixed so as to vibrate with the membrane in direct relationship with the input acoustic signals. Fixed optical fibers are disposed in alignment with the lens in order to orient the initial light toward the lens and to transmit the oriented light from the lens.

Also in the prior art, an optical sensor/microphone described in U.S. Pat. No. 6,462,808, is known. It comprises a light source coupled to a waveguide so as to transmit a light beam. One of the ends of the waveguide has a surface in a point with an angle determined by Snell's refraction law:

sin alpha1/sin alpha2=n1/n2 in which:
alpha1 is the path angle of the light beam through the waveguide medium,
alpha2 is the path angle of the light beam in the second medium at the exit from the pointed surface,
n1 and n2 are the light indices of the light waveguide medium and the second medium.

A reflective surface is disposed at an optimum distance with respect to the pointed surface determined by the angle alpha2. The waveguide has, at its external surface, at least adjacently, means for preventing the light waves being reflected on the surface by back-reflection effect in the waveguide. A light detector arranged to receive the light reflected from the reflective surface.

In the prior art, metrology solutions are also known, which are not transducers but equipment for distance measurement.

The international application U.S. Pat. No. 6,239,865 describes an example of a sensor and method for measuring the distance and/or the physical properties of a material. This document describes a sensor for measuring distances to a medium and/or physical properties, including a housing, and at least one pair of optical fibers, each having an entry end part and an exit end part. The entry end part of the first optical fiber can be connected to a light source and the exit end part of the second optical fiber can be connected to light-intensity measurement means. A sensor head, including the entry end part of the second optical fiber, is disposed in the vicinity of the exit end part of the first optical fiber.

These two ends form between them an angle theta with respect to the axis, the light emerging from the exit end part of the first optical fiber being reflected by a surface of a medium at an angle of incidence beta and in which the angle beta=f(alpha, theta).

Also in the prior art, the patent FR 2739445 is known, the content of which is incorporated in the present patent by citation. This patent does not relate to a transducer, but contains teaching on a method of physical measurement by reflectometry, comprising an essential calibration step. It describes a device forming an optical sensor comprising an optical fiber having a polished end with at least two inclined secant planes forming a diopter in a roof or pyramid shape and another end coupled to a photoemitter/photodetector assembly, a means suitable for moving the polished end in a controlled fashion relative to a sample, as well as means for analyzing the return light, returning through the fiber. The intensity of this return light obeys an intensity response curve (I) that can be calibrated according to the distance (Z) to the sample as well as its optical characteristics and has a maximum (A) at a fixed distance from the sample. The analysis means are arranged to determine one of the quantities of the group comprising the relative or absolute position of the sample and at least one of the optical characteristics thereof.

### Drawbacks of the Prior Art

The solutions of the prior art relating to optomechanical transducers have several drawbacks.

Some solutions require the use of a plurality of fibers, one for the incoming beam, and the other for the outgoing beam. This considerably complicates use in hostile environments.

Moreover, the solutions of the prior art require an assembly that is complex both optically and mechanically. These solutions lead to transducers that are fragile, difficult to adjust and unstable.

Finally, the solution proposed by the patent FR 2739445, for distance measurement, involves an operating point of the optical head that is very sensitive and causes significant drifts in performance at the least mechanical variation, in particular, in the case of maladjustment or changes to positioning under the effect of thermal expansion.

The teaching of the documents relating to metrology methods and equipment is suited to measurements of static distance.

### BRIEF SUMMARY

The method that is the subject matter of this patent, the purpose of which is a distance measurement, comprises the following steps:

a) providing an optical fiber having a polished end in at least two planes inclined with respect to the axis of this fiber and secant, forming a diopter in a roof or pyramid shape, the light issuing from the fiber being thus divided into at least two convergent beams,

b) subjecting the polished end of this fiber to a controlled relative movement in the vicinity of a target sample,

c) causing a light of known characteristics to come through the fiber,

d) measuring the intensity of the return light, returning through the fiber, after reflection on the sample, this measurement of the return light being an intensity response curve (I) that can be calibrated according to the distance (Z) to the sample as well as optical characteristics of the sample, and which has a maximum (A) at a substantially fixed distance from the sample, and analyzing this intensity according to the relative movement, with a view to determining one of the quantities of the group comprising, on the one hand, the relative or absolute position of the sample, and on the other hand, at least one of the optical characteristics of the sample.

### Solution Provided by the Invention

In order to remedy the drawbacks of the prior art, the disclosure relates, in its most general acceptance, to an optomechanical transducer comprising an optical fiber having a polished pointed distal end placed facing the reflective surface and a proximal end connected to a coupler combining an illumination optical fiber associated with a light source and a measurement optical fiber associated with a photodetector, characterized in that the reflective element has a movable zone with an axial component, the axial distance between the distal end of the optical fiber and the reflective surface at rest is determined so that the reflected light intensity I0 is equal to P·Imax where Imax designates the maximum reflected light intensity and P is a parameter between 0.25 and 0.75.

“Distal” will mean the side of the fiber intended for acquiring physical phenomena, and “proximal” the side where the processing electronics is situated, and the optical coupler. Between the two ends the single optical fiber extends, which may have great length, typically several hundreds of meters or even kilometers for applications such as marine hydrophone networks.

Preferably, the distal end of the optical fiber has at least two secant polished facets forming a diopter in a roof, pyramid or cone shape.

According to a first variant, the movable zone consists of an elastically deformable membrane.

According to a particular variant, the deformable membrane is fixed peripherally to a rigid frame mechanically connected to the support of the distal end of the optical fiber.

According to a particular embodiment, the end comprising the distal end of the optical fiber and the membrane are encapsulated in an envelope having a vent at the front and rear of the membrane for balancing static pressures.

According to another embodiment, the membrane has a resilient suspension.

According to a second variant, the movable zone consists of a resilient blade fixed by one end to a rigid frame mechanically connected to the support of the distal end of the optical fiber. The natural frequency of the blade is between 1 hertz and 1 kilohertz.

According to a particular embodiment, the resilient blade is fixed by one end to a rigid frame mechanically connected to the support of the distal end of the optical fiber, the natural frequency of the blade being greater than 5 hertz.

According to another embodiment, the movable zone consists of a flexible blade fixed by one end to a rigid frame mechanically connected to the support of the distal end of the optical fiber, the natural frequency of the blade being less than 5 hertz.

According to another particular embodiment, the optical fiber comprises, on the distal side, a multiplexer providing the coupling of a plurality of segments of optical fibers each having a pointed distal end positioned facing the reflective surface.

According to another particular embodiment, the optical fiber comprises, on the proximal side, a multiplexer providing the coupling of a plurality of pairs of optical fibers each functioning at a distinct wavelength band.

The disclosure also relates to various applications of this inventive concept.

It relates, in particular, to an optomechanical microphone, a manometer or an optomechanical pressure sensor comprising an optical fiber having a polished pointed distal end placed facing a reflective surface and a proximal end connected to a coupler combining an illumination optical fiber associated with a light source and a measurement optical fiber associated with a photodetector, characterized in that the reflective element is formed by a deformable membrane having a movable zone with an axial component, the axial distance between the distal end of the optical fiber and the reflective surface at rest is determined so that the reflected light intensity I0 is equal to P·Imax where Imax designates the maximum reflected light intensity, and P is a parameter between 0.25 and 0.75.

It also relates to an optomechanical sonar or a hydrophone comprising an optical fiber having a polished pointed distal end placed facing a reflective surface and a proximal end connected to a coupler combining an illumination optical fiber associated with a light source and a measurement optical fiber associated with a photodetector, characterized in that the reflective element is formed by a deformable membrane having a movable zone with an axial component, the axial distance between the distal end of the optical fiber and the reflective surface at rest is determined so that the reflected light intensity I0 is equal to P·Imax where Imax designates the maximum reflected light intensity, and P is a parameter between 0.25 and 0.75, the sonar comprising a pipe for balancing the static pressure exerted on the two faces of the membrane.

It also relates to an optomechanical vibration sensor or an optomechanical biological sensor comprising an optical fiber having a polished pointed distal end placed facing a reflective surface and a proximal end connected to a coupler combining an illumination optical fiber associated with a light source and a measurement optical fiber associated with a photodetector, characterized in that the reflective element is formed by a deformable vibrating beam secured to a rigid support for fixing to the distal end of the optical fiber, the vibrating beam having a movable zone with an axial component, the axial distance between the distal end of the optical fiber and the reflective surface at rest is determined so that the reflected light intensity I0 is equal to P·Imax where Imax designates the maximum reflected light intensity, and P is a parameter between 0.25 and 0.75. With regard to the biological sensor, the beam is coated with a surface activator able to interact specifically with a biochemical component.

It also relates to a drill head or a Pitot probe comprising an optomechanical pressure sensor comprising an optical fiber having a polished pointed distal end placed facing a reflective surface and a proximal end connected to a coupler combining an illumination optical fiber associated with a light source and a measurement optical fiber associated with a photodetector, characterized in that the reflective element is formed by a deformable membrane having a movable zone with an axial component, the axial distance between the distal end of the optical fiber and the reflective surface at rest is determined so that the reflected light intensity I0 is equal to P·Imax where Imax designates the maximum reflected light intensity, and P is a parameter between 0.25 and 0.75.

### BRIEF DESCRIPTION OF THE FIGURES

This disclosure will be better understood from a reading of the following description relating to non-limitative example embodiments and referring to the accompanying drawings, where:

FIG. 1 shows a schematic view of a sensor according to the disclosure;

FIG. 2 shows a schematic view of the distal end of the fiber;

FIG. 3 shows the measurement diagram of the reflected intensity as a function of the distance between the distal end of the fiber and the reflective surface;

FIG. 4 shows a schematic view of a variant embodiment;

FIG. 5 shows the measurement diagram of the reflected intensities of different wavelengths as a function of the distance between the distal end of the fiber and the reflective surface for this variant embodiment;

FIG. 6 shows a schematic view of a second variant embodiment;

FIG. 7 shows the measurement diagram of the reflected intensity as a function of the distance between the distal end of the fiber and the reflective surface for this second variant embodiment;

FIG. 8 shows a schematic view of a third variant embodiment; and

FIG. 9 shows a schematic view of a fourth variant embodiment.

### DETAILED DESCRIPTION

### Description of the General Principle of a Transducer According the Invention

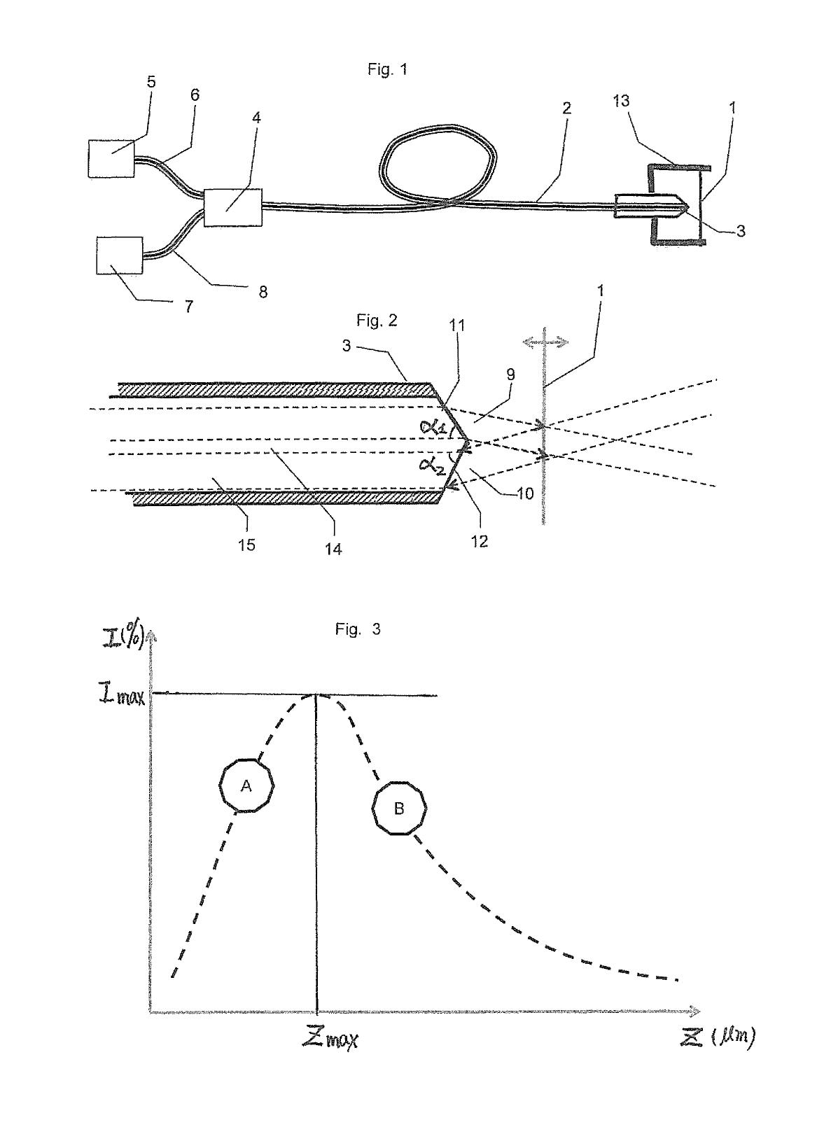

The disclosure relates, in the first example embodiment illustrated by FIGS. 1 to 3, to a transducer intended to measure the variations in pressure exerted on a membrane (1). Such a transducer can be used for capturing sounds, and thus form a microphone or a sonar or a hydrophone when the medium in which it is disposed is liquid. It may also constitute a pressure sensor for measuring very low pressures, or on the contrary high pressures, for example, for analyzing explosions.

The transducer comprises an optical fiber (2) having a polished distal end (3) followed by at least two planes (faces) inclined with respect to the axis of this fiber and secant, forming a diopter in a roof or pyramid shape.

The proximal end of the fiber (2) is connected to a Y-shaped fibrous coupler (4) making it possible to mix:
an input signal coming from a light source (5) by means of a first portion of fiber (6), and
an output signal transmitted to a photodetector (7) by means of a second portion of fiber (8).

The single optical fiber (2) is used at the same time as a sender (conveying light emitted by the light source (5)) and a receiver (collecting light reflected on the reflective membrane (1)), which considerably reduces the manufacturing costs and the space requirement, while allowing measurement at a distance from the sample as great as requirements so necessitate.

The fiber (2) transmits a beam (9) in a direction corresponding to the angle of refraction of the fiber, defined by the indices of the core of the fiber and of the outside environment.

A part (10) of the light (referred to as the return light) that is reflected on the reflective surface of the membrane (1) enters the fiber (2) through the distal end (3). In the example described, the membrane (1) extends in a plane perpendicular to the axis of the distal end (3) of the optical fiber.

The intensity of the light that returns in the fiber varies according to the distance between the distal end of the fiber and the surface of the membrane (1), with a response curve shown in FIG. 3, corresponding to the intensity I of the return light as a function of the fiber-membrane distance Z.

The end (3) of the fiber is polished on at least two planes (11, 12) inclined respectively by an angle Alpha1 and Alpha2 (preferably equal) with respect to the axis normal to the cross section of the fiber and secant in a roof or pyramid shape. This end has a response curve substantially in a bell shape and consequently having a maximum. Such a curve is shown in FIG. 3, where the reflected relative intensity is shown as a percentage (%) of the reflected maximum intensity as a function of the membrane-fiber distance Z in micrometers (μm).

Zmax depends essentially on the angle Alpha, while Imax depends on the type of fiber and the optical characteristics of the surface of the sample (mainly its reflectivity at the wavelength of the sensor light). The larger the angle Alpha, the larger is Zmax. Preferably, this angle Alpha must be chosen in the range 50 degrees to 85 degrees.

Moreover, the narrower the light beam emitted by the fiber, which depends on the numerical aperture of this fiber, the higher the peak of the response curve.

Consequently, when the sampling of a fiber is carried out by means of a plurality of samples, it is possible to produce a table of pairs of data relating to each sample, each pair comprising a maximum intensity data item or Imax and a maximum distance data item or Zmax.

The idle distance between the distal end of the fiber (3) and the surface of the membrane (1) is determined so as to be positioned on the curve in FIG. 3 through two points A and B, A being positioned at the rising slope of the curve and B being positioned at the descending part of the curve. These points A and B are placed where the change in the reflected light intensity is the most sensitive with respect to the change in the position of the membrane. This position can be determined experimentally, by respective adjustments of the position at rest of the membrane (1), or by calculation, or by pre-adjustment for mass production of a set of transducers with the same characteristics.

The distance is determined so that the reflected light intensity I0 is equal to P·Imax where Imax designates the maximum reflected light intensity, and P is a parameter between 0.25 and 0.75.

The membrane (1) is suspended with respect to a rigid frame (13) also providing the holding and positioning of the distal end (3) of the optical fiber.

The suspension can be achieved in any known way, for example, by the periphery of an elastically deformable membrane, for example, a metalized sheet.

Depending on the application sought, great stiffness will be sought, to allow the detection of high-frequency acoustic vibrations, or on the other hand very low stiffness, to measure small variations in pressure.

The fiber (2) comprises a core (14) of index n1 surrounded by a sheath (15) of index n2.

The end is cut so as form two secant planar surfaces in the example described.

Naturally, there may be three planes, four planes or even more, forming a pyramid or a cone, or it can be envisaged using two planes inclined at two different angles, or a conical shape.

Moreover, the fiber may be of any type, such as, for example, monomode or multimode, and with an index gradient or an index jump.

For example, a fiber of the 100/140 multimode type with an index jump will be chosen, comprising two planes inclined by the same angle O of approximately 75 degrees with respect to its axis, which corresponds to a maximum fiber-sample distance of approximately 150 μm.

### BRIEF DESCRIPTION OF THE DRAWINGS

### Description of a First Variant Embodiment

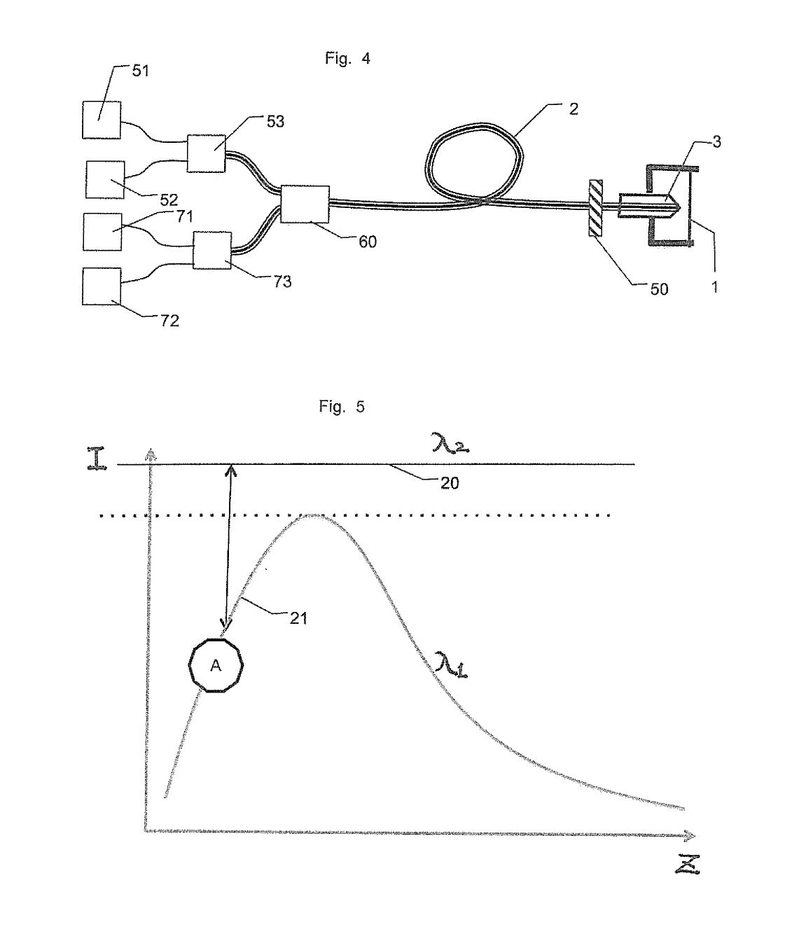

FIG. 4 shows a variant embodiment where the light source comprises two distinct wavelengths, produced by a first source (51) in a wavelength lamda₂ and a second source (52) emitting in a wavelength lamda₁, these two sources transmitting the light by means of optical fibers coupled by a Y coupler (53) to the main fiber (2).

Likewise, the detection comprises a first photodetector (71) for measuring the light in the band lamda₁ and a second photodetector for measuring light in the band lamda₂, receiving beams by means of a coupler (73). The main optical fiber (2) is connected to a WDM (wavelength division multiplexing) multiplexer (60) that makes it possible to pass a plurality of signals with different wavelengths over the same optical fiber, by mixing them at the entry by means of a multiplexer (MUX) and separating them at the exit by means of a demultiplexer (DEMUX).

The distal end of the fiber (2) is equipped with a band-rejection filter blocking and reflecting one of the wavelengths Lamda₂.

The wavelength Lamda₁ therefore produces a response illustrated in figure by the curve (21), whereas the curve (20), which is substantially constant, represents the response for the wavelength Lamda₂ blocked by the filter (50).

The curve (21) varies not only as a function of the distance between the distal end (3) and the membrane, but also as a function of the endogenous variations of the fiber (2) due for example, to variations in temperature, curvature of the fiber, aging of the fiber, etc. The endogenous variations of the fiber (2) are also presented in the curve (20).

Consequently, measuring the difference in light intensity in the two wavelengths lamda₁ and lamda₂ makes it possible to obtain a response independent of the external artefacts: the variations due not to the movement of the membrane (1) but to variations in the intensity in the main fiber (2) or through the upstream components are neutralized by a subtraction of the signals measured by the two photodetectors (71, 72).

An alternative consists of using a single stretched-spectrum light source and two filters with different passbands for producing two beams with wavelengths lamda₁ and lamda₂.

### Description of a Second Variant Embodiment

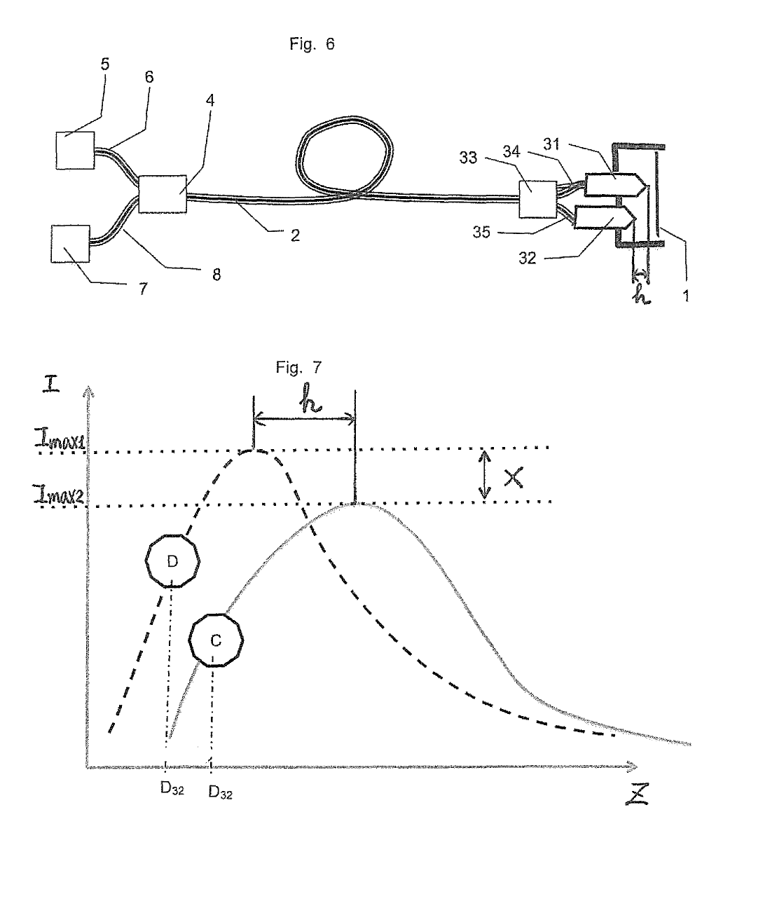

FIG. 6 shows a second variant embodiment where the acquisition head comprises two (or more) measuring tips (31, 32) positioned facing the same membrane (1).

A coupler (33) situated at the distal end of the main fiber (2) transmits the light to two optical fiber segments (34, 35) the end of which is cut in a point as described previously.

There are two pointed sensors (31, 32) positioned facing the reflective surface but offset in the axial direction from each other by a known distance h. This distance is the same as that between the two reflected-intensity maxima of the two pointed sensors shown in FIG. 7. When the membrane is at a distance such that there is a maximum intensity, the other point may be at any, but non-maximum, position. When the signal passes from one maximum intensity to another maximum intensity, then the movement made by the membrane in the axial direction is known perfectly since it corresponds to the distance between the two points in the axial direction that is defined when the optical fibers are mounted on the fixed support. It is for this reason that the system can be termed “self-calibrating”. In FIG. 7, the difference in intensity “x” between the two curve maxima depends on various parameters such as the nature of the point used with respect to the other point, the attenuations of the signal, which may differ between the two points, etc. This difference “x” may be zero or non-zero.

### Description of a Third Variant Embodiment

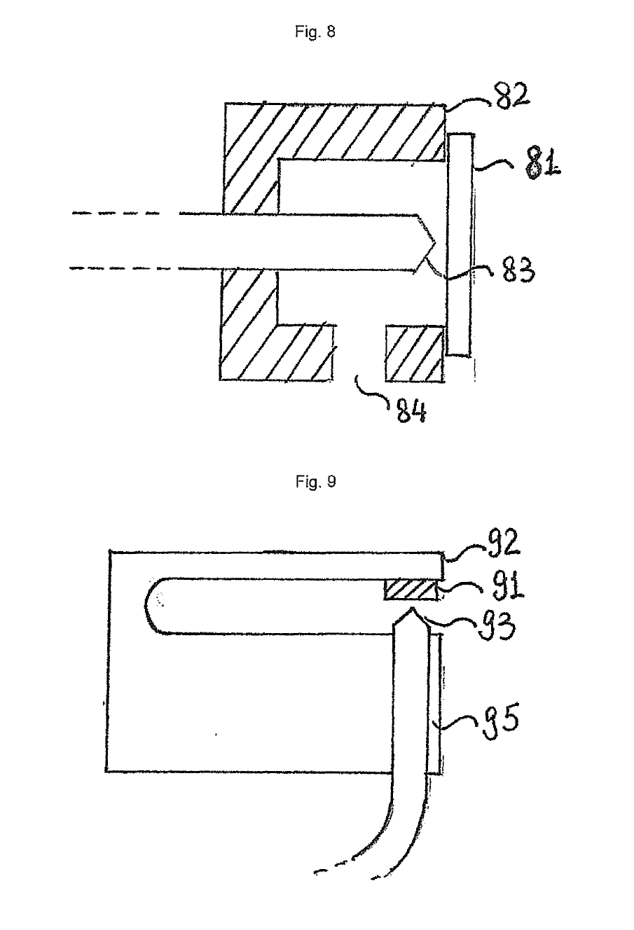

FIG. 8 presents a variant embodiment where the distal end of the optical fiber (83) and the membrane (81) are encapsulated in an envelope. The envelope is formed by a rigid frame (82), which is mechanically connected to the support of the distal end of the optical fiber in one side, and on which the membrane is fixed peripherally in another side. The envelope has a vent (84), which connects the internal cavity delimited by the envelope with the external environment. The materials, in the gas or liquid states, can circulate freely through the vent in order to achieve equilibrium between the internal cavity pressure P1 and the pressure P2 of the external environment.

### Description of a Fourth Variant Embodiment

FIG. 9 shows a variant embodiment where the reflective element, for example, a mirror (91), is present on a vibrating plate (92). One end of the vibrating plate is mechanically connected to the support (95) of the distal end of the optical fiber (93). The frequency of vibration of the blade varies from 1 hertz to 1 kilohertz depending on the form and the material that constitute this plate, for example, a resilient metal plate.

Another possibility is to attach the optical-fiber support to another support the vibration of which it is sought to measure, for example, a motor. While the optical-fiber support follows the movement of the motor, the movable zone of the reflective element does not follow this movement because of the weak coupling through the end. The axial distance between the distal end of the optical fiber and the reflective surface changes according to the movement of the motor. By analyzing the reflected light intensity, the vibratory movement of the motor can be clearly illustrated.

1. An optomechanical transducer comprising an optical fiber having a polished pointed distal end placed facing the reflective surface and a proximal end connected to a coupler combining an illumination optical fiber associated with a light source and a measurement optical fiber associated with a photodetector, characterized in that the reflective element has a movable zone with an axial component, the axial distance between the distal end of the optical fiber and the reflective surface at rest is determined so that the reflected light intensity I0 is equal to P·Imax where Imax designates the maximum reflected light intensity and P is a parameter between 0.25 and 0.75.

2. An optomechanical transducer according to claim 1, wherein the distal end of the optical fiber has at least two secant polished facets forming a diopter in a roof, pyramid or cone shape.

3. An optomechanical transducer according to claim 1, wherein the movable zone is formed by an elastically deformable membrane.

4. An optomechanical transducer according to claim 1, wherein the movable zone is formed by a deformable membrane fixed peripherally to a rigid frame mechanically connected to the support of the distal end of the optical end of the optical fiber.

5. An optomechanical transducer according to claim 3, wherein the end of the fiber comprising the distal end of the optical fiber and the membrane are encapsulated in an envelope having a vent for balancing static pressures.

6. An optomechanical transducer according to claim 3, wherein the membrane has a resilient suspension.

7. An optomechanical transducer according to claim 1, wherein the movable zone is formed by a resilient blade fixed by one end to a rigid frame mechanically connected to the support of the distal end of the optical fiber, the natural frequency of the blade being between 1 hertz and 1 kilohertz.

8. An optomechanical transducer according to claim 1, wherein the movable zone is formed by a flexible blade fixed by one end to a rigid frame mechanically connected to the support of the distal end of the optical fiber, the natural frequency of the blade being less than 5 hertz.

9. An optomechanical transducer according to claim 1, wherein the optical fiber comprises on the distal side a multiplexer providing the coupling of a plurality of segments of optical fibers each having a pointed distal end positioned facing the reflective surface.

10. An optomechanical transducer according to claim 1, wherein the optical fiber comprises on the proximal side a multiplexer providing the coupling of a plurality of pairs of optical fibers each functioning at a distinct wavelength band.

11. An optomechanical microphone comprising an optomechanical transducer as recited in claim 1.

12. An optomechanical sonar comprising an optomechanical transducer as recited in claim 1, the sonar comprising a pipe balancing the static pressure exerted on the two faces of the membrane.

13. An optomechanical manometer comprising an optomechanical transducer according to claim 1.

14. An optomechanical vibration sensor comprising an optomechanical transducer according to claim 1, and further comprising a reflective element formed by a deformable vibrating beam secured to a rigid support for fixing to the distal end of the optical fiber, the vibrating beam having a movable zone with an axial component, the axial distance between the distal end of the optical fiber and the reflective surface at rest is determined so that the reflected light intensity I0 is equal to P·Imax where Imax designates the maximum reflected light intensity, and P is a parameter between 0.25 and 0.75.

15. An optomechanical biological sensor comprising an optomechanical transducer according to claim 1, further comprising a reflective element formed by deformable vibrating beam secured to a rigid support for fixing to the distal end of the optical fiber, the vibrating beam having a movable zone with an axial component, the axial distance between the distal end of the optical fiber and the reflective surface at rest is determined so that the reflected light intensity I0 is equal to P·Imax where Imax designates the maximum reflected light intensity, and P is a parameter between 0.25 and 0.75, the beam being covered with a surface activator able to interact specifically with a biochemical component.

16. A drilling head comprising an optomechanical pressure sensor comprising an optomechanical transducer according to claim 1.

17. A Pitot sensor comprising an optomechanical pressure sensor comprising an optomechanical transducer according to claim 1.
